(19) United States
(12) Patent Application Publication
(10) Pub. No.: US 2003/0144616 A1
(43) Pub. Date: Jul. 31, 2003

(54) Massage device

(76) Inventor: James A. Henderson, Oakland, CA (US)

Correspondence Address: James W. Peterson, BURNS, DOANE, SWECKER & MATHIS, L.L.P., P.O. Box 1404, Alexandria, VA, 22313-1404, US

(21) Appl. No.: 10/348,215

(22) Filed: Jan. 21, 2003

Related U.S. Application Data
(63) Continuation of application No. 09/273,534, filed on Mar. 22, 1999, now abandoned.

(51) Int. Cl. A61H 15/00

(52) U.S. Cl. 601/131; 601/132; 601/135; 601/137

(57) ABSTRACT

A massage device for massaging all major muscle groups is disclosed. The device includes two spherical massaging balls housed in an elongated, permanently closed sac. The sac is sized so that the relative position of the balls is variable within the sac when the device is not in use. The balls are free rolling and are not connected to a separate device.

### FIELD OF THE INVENTION

The present invention relates to a massage device. More particularly, the present invention relates to a massage device that releases muscle tension in all major muscle groups of the body.

### BACKGROUND OF THE INVENTION

Muscle strain and tightness of joints is a problem that has plagued millions of people worldwide. There have been many attempts over the years to devise a massage device which functions to release tension of strained muscles, and to mobilize various joints. Massage therapists, chiropractors, acupuncturists and physical therapists have developed their own manual techniques, including the use of massage devices, to temporarily relieve patients of muscle and joint ailments.

For instance, U.S. Pat. No. 2,748,763, issued to Kosloff, discloses a massage device, for massaging various parts of the human body. The massage device includes an elongated semi-circular outer shell having a plurality of rows of curved troughs supported on and partially enclosed by the shell. Each trough has a plurality of massage balls freely mounted therein. A handle is attached to the outer shell for manipulating the device.

While the massage device accomplishes massaging of various muscle groups, because of its size, it can not adequately pinpoint and massage certain muscle groups. In addition, because there is a handle on the outer shell of the device, manipulation of the device on a person's back requires that another person actually operate the device. Thus, the device can not be used to massage all muscle groups, and for certain areas of a person's body, can not be used without the assistance of another person.

Similarly, U.S. Pat. No. 5,735,803, issued to Musilli et al., discloses a hand-operated massage device. The device includes a plurality of massage elements supported on a shaft for independent rotation about a first axis, and a handle mounted on the shaft to extend along a second axis in an orthogonal direction relative to the first axis. The shaft is bent into a configuration such that an imaginary plane including the first axis and substantially normal to the second axis intersects the handle between front and rear ends of the handle.

In this way, the handle is positioned directly over the rotatable massaging elements and extends in a direction of movement of the device. This provides a better directional control as it is moved over a person's body, while allowing the user to apply massage pressure in an efficient manner. However, like the massage device disclosed by Kosloff, manipulation of the device on a person's back requires assistance from another person. In addition, because the balls are fixed on the axis, the device can not pinpoint and massage specific muscle groups.

U.S. Pat. No. 4,796,616, issued to Panahpour, discloses a massaging apparatus having a plurality of balls mounted in laterally and longitudinally spaced openings in a carrier. The balls are positioned in the opening so that a portion of the ball projects beyond the generally planar plates of the carrier. The balls are mounted so as to enable the balls to be compressed and freely rotated in all directions when one projecting ball portion is in contact with the floor or other relatively rigid surface.

However, while this device is adapted for massaging action without assistance from another person to massage areas of the back, the balls are permanently positioned in the device, making manipulation and massage of specific muscle groups very difficult. Moreover, the device is rather complicated and relatively expensive to manufacture.

U.S. Pat. No. 5,577,995, issued to Walker et al., discloses a therapeutic device to mobilize the spinal joints and soft tissues surrounding the human spine. The device includes two substantially solid spherical balls mounted on a shaft for independent rotation. The balls may be mounted on the shaft by suitable sleeves disposed through the inner ball portions.

While most prior art devices are limited to application by another person, the massage device disclosed in Walker et al. accomplishes self massage of a user's back. However, because the massage balls are affixed to a shaft, the elasticity of the balls is restricted, providing a surface contact that is often too rigid, and potentially damaging to a unskilled user's body.

In addition, the balls are permanently affixed to the shaft, preventing the positional adjustment of the balls on the shaft, so that various muscle groups may be massaged. Finally, the device of Walker et al. is specifically designed to massage areas of the back. As such, the device of Walker et al. lacks versatility, in that it can not exercise all major muscle groups of the body.

U.S. Pat. No. 5,577,996, issued to Gardner et al., discloses a hand held massage device very similar to the patent issued to Walker et al. The massage device includes a plurality of spheres adjustably mounted on the outer ends of the rod for rotation. The massage device is easy to use and, because the handles are in axial aligmnent with the massage spheres, allows the user to apply and direct the desired amount of pressure. However, the massage device disclosed by Gardner et al. has similar disadvantages to those discussed with regard to the device disclosed bu Walker et al. For instance, because the balls are affixed to a rod, the elasticity of the balls is restricted, providing too rigid of a contact with a person's body to be massaged.

In addition, while the balls of Gardner et al. are adjustably mounted on the shaft, the balls are not easily adjusted. Gardner et al. specifically discloses that the hole through each ball is slightly smaller than the circumference of the rod in order to maintain the position of the balls during use of the device. Accordingly, it becomes difficult to change the position of the balls, and requires the user to somehow mount the device, while applying a significant force in the appropriate direction. Finally, like the device of Walker et al., the device of Gardner et al. is specifically constructed to be used on the back, and thus, is not versatile.

Accordingly, there is a need for a massage device that can be operated without assistance from another person. In addition, there is a need for a massage device that is relatively simple in construction, durable, and inexpensive to manufacture. Further, there is a need for a massage device that can pinpoint and massage all major muscle groups, that is easily adjustable and simple to use. Finally, there is a need for a massage device that allows for a greater sense of flexibility, enhanced sense of movement, and reduction of pain and stiffness.

### SUMMARY OF THE INVENTION

It is an object of the invention to provide a massage device that can be operated without assistance from another person.

It is yet another object of the invention to provide a massage device that is relatively simple in construction, durable, and inexpensive to manufacture.

It is yet a further object of the invention to provide a massage device that can pinpoint and massage all muscle groups, that is easily adjustable and simple to use.

It is still yet a further object of the invention to provide a massage device with few moving parts, which is easily operated by an unskilled person, yet highly effective in massaging all major muscle groups.

It is still yet another object of the invention to provide a massage device that allows for a greater sense of flexibility, enhanced sense of movement, and reduction of pain and stiffness.

The above listed objects of the invention are accomplished according to the massage device of the present invention. The massage device includes first and second spherical massaging balls and an elongated, permanently closed sac for housing the balls. The sac is sized so that the relative position of the balls is variable within the sac when the device is not in use. The balls are free rolling and are not connected to a separate device.

### BRIEF DESCRIPTION OF THE DRAWINGS

Further features and characteristics of the present invention will become more apparent from the following detailed description considered with reference to the accompanying drawing figures, wherein:

FIG. 1 is a side view of the massage device of the present invention, showing the sac with two massage balls in hidden lines;

FIG. 2 is an end view of the massage device illustrated in FIG. 1; and

FIG. 3 is a side view of the massage device of the present invention, with a portion of the sac broken away and one massage ball partially in cross-section.

### DETAILED DESCRIPTION OF THE PREFERRED EMBODIMENT

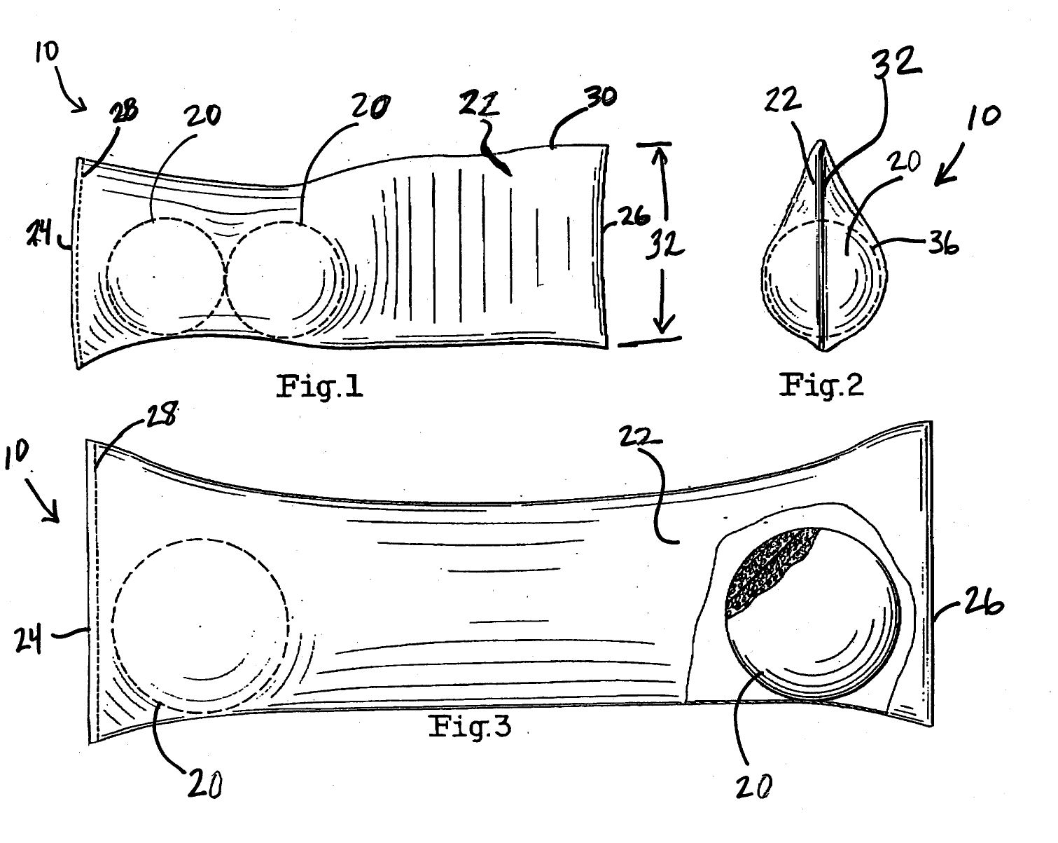

The massage device of the present invention is adapted to be used in accordance with specific exercises for massaging all major muscle groups. With reference to FIG. 1, the massage device 10 includes two spherical balls 20 enclosed in an elongated sac 22.

The spherical balls 20 are free rolling within the sac 22 and are not attached to a separate device. In this way, the position of the balls 20 within the sac is variable, and can be easily adjusted to different positions within the sac 22. That is, the balls 20 may be strategically positioned within the sac 22, so as to accomplish massage of specific muscles groups.

In the preferred embodiment, the balls 20 are solid, and made from rubber. However, it should be understood that the balls may be hollow or solid, according to an amount of resistance desired from the balls. In addition, the type of material used for the balls 20 should be determined according to the amount of pressure desired to be applied to the specific areas of the body, and was most preferably found to be rubber. Rubber is sufficiently strong to provide the desired pressure to specific areas, yet soft enough in order to prevent injury to certain areas of the body during use. However, other materials may be used, such as a solid foam-like material, as shown with reference to FIG. 3.

The outer surface of the balls 20 should be made from a material so that the balls 20 become frictionally engaged to the sac 22 when the device 10 is in use, yet freely adjustable when the device 10 is not in use. In the preferred embodiment, the outer surfaces of the balls 20 are also made from rubber, which provides sufficient frictional engagement with the material of the sac 22, which will be described in more detail below.

The balls 20 are sized so that an optimal massaging action is accomplished for all regions of the body. When using the device 10 to massage the back, the balls 20 must be sized to comfortably massage a person's back, as well as other muscle groups. If the balls 20 are too large, as in the case of a tennis ball, there is too much distance between the floor or other surface and the user's back, forcing the user to arc their back, resulting in discomfort. If the balls 20 are too small, the balls 20 will not provide adequate pressure to accomplish massaging of the muscles. Preferably the balls 20 should be approximately between 2.25 and 2.5 inches in diameter, and most preferably approximately 2.5 inches in diameter. However, it should be understood that larger or smaller sized balls may be used, according to preference.

The balls 20 used in a preferred embodiment are distributed by a company called HedStrom Corporation, located in Chicago, Ill., and are called “Super Pinky” balls. These balls have a diameter of about 2.5 inches. The size and density of the balls 20 are important for providing the appropriate resistance for the user to efficiently release areas of tension in the user's body.

With reference to FIGS. 1-3, the sac 22 should be sized so that the balls 20 move freely within the sac 22 when the device 10 is not in use, but large enough so that the balls 20 remain stationary within the sac 22 during use. The dimensions of the sac 22 are also important, so that various massage exercises may be performed.

In particular, the length 30 of the sac 22 is between the ranges of 8 to 14 inches, and preferably 10-12 inches. This length 30 must be sufficiently long so as to permit the device 10 to be used to massage muscle groups of both sides of the body. That is, the balls 20, when they are completed separated and adjacent respective ends 24 and 26 of the sac 22, should be sufficiently long so that muscle groups on both sides of the body can be evenly massaged.

In addition, the balls 20 should be able to be positioned within the sac 22 so that they may be sufficiently spaced, in order for a single ball 20 to be used independently of use of the other ball 20. That is, the sac 22 should be sufficiently long so that the other ball 20 does not interfere with the massaging ability of a single ball by itself. In this manner, the device 10 can be used with both balls to equally massage both sides of the body, while allowing a single ball to be used to massage an isolated area of the body.

The width 32 of the sac 22, which is hereby defined as the width of the device in its manufactured condition, and specifically the width of the sac 22 at its ends 24 and 26, is slightly larger than the diameter of the balls 20, but small enough so that the balls 20 maintain their relative position within the sac 22. That is, the balls 20 can not reverse positions within the sac 22.

The width 32 of the sac 22 should be between about 3 to 5 inches, and most preferably about 4 inches. Ideally, the width 32 of the sac 22 should be between approximately 30 and 50% larger than the diameter of the balls. With reference to FIG. 2, a side view of the device is shown, illustrating the loose fit of the balls 20 within the sac 22, while permitting enough room so that the position of the balls 20 is variable. This range permits the balls 20 to be readily moved in the sac 22 while adjusting the device 10, while restricting movement of the balls 20 within the sac 22, when the device 10 is in use.

In order to construct the device, the sac 22 is preferably made from a rectangular piece of material. In this way, the sac 22 is manufactured by folding the rectangular piece of material in half, resulting in a two-fold material, and permanently sewing the three open edges of the material. However, it should be understood that the open edges may also be secured by adhesive, or any other permanent securing means.

Alternatively, two of the three edges may be sewn, and then the material turned inside out. The balls 20 may then be placed into the sac 22, and then the third edge is secured, resulting in only one edge of the sac 22 revealing a seam 28, as shown with reference to FIGS. 1 and 3.

However, the sac 22 may be made in any other way, so long as a symmetrical and elongated structure is accomplished. That is, both ends 24 and 26 are substantially identical in shape and should be symmetrical, so as to accomplish symmetrical and even massage of both sides of the body.

The sac 22 should be made from a material such that enough friction is provided between the outer surfaces of the balls 20 and the sac 22 so that the balls do not become loose while using the device. Preferably, the sac 22 is made from nylon, because it is lightweight and durable, yet provides sufficient friction between the balls 20 and the sac 22 so that the balls do not come loose. However, it should be understood that the sac 22 may be made from any other fabric, such that sufficient friction is accomplished between the sac 22 and the balls 20.

Accordingly, the massage device 10 of the present invention is so designed so that many massage exercises can be accomplished. The device 10 may be used to massage various muscles of the back, functioning to release tension along the spine, while lengthening the spine and improving flexibility of the vertebrae.

For instance, the user may lay on the floor and the two pressure balls 20 may be placed at the base of the spine, one on each side of the spine. In order to release tension along the spine, the user moves the pressure balls along the spine, by pushing with their feet to roll the balls 20 on the spine. The fabric of the sac 22 creates sufficient frictional tension so that the balls 20 do not become released during the exercise, but roll smoothly and in synchronization with the sac 22. The massage device 10 can also be used to massage the back while the user sits in a chair, or can be placed between the user and a support surface.

In addition to various back exercises, the device 10 can be used to exercise all major muscle groups, including stomach muscles, foot muscles, calf muscles, neck muscles, and quadriceps. The device 10 is designed and specifically sized so that all areas of the back can be massaged evenly, as well as providing a sac 22 that is long enough to isolate a massage ball 20 to individually massage a specific area.

For instance, in order to massage the quadriceps, a massage ball 20 is isolated from the other ball, and placed between the floor and a user's hip. The user brings his or her hip against the pressure ball 20, holding for two to three minutes, and then releasing.

Another exercise that requires the use of one ball, is an exercise for massaging muscle areas adjacent the pelvis. The user lies flat on his or her stomach. The pressure ball is placed inside the front part of the pelvis where it touches the floor. The user then relaxes his or her body onto the ball, in order to release tension in the area of the pelvis.

Thus, the dimensions of the device 10 provide for use both balls 20 simultaneously on certain exercises, while a single ball 20 can be isolated for use for a specific area of the body. In this way, the device 10 is more versatile than that of the prior art, as well as simple in construction, and easy to use.

The principles, preferred embodiments and manner of use of the present invention have been described in the foregoing specification. However, the invention which is intended to be protected is not to be construed as limited to the particular embodiments described. Further, the embodiments described herein are to be regarded as illustrative rather than restrictive. Variations and changes may be made by others, and equivalents employed, without departing from the spirit of the invention. Accordingly, it is expressly intended that all such variations, changes and equivalents which fall within the spirit and scope of the invention be embraced thereby.

I claim:

1. A massage device for releasing tension of muscles, comprising:
first and second spherical massaging balls; and
an elongated, closed sac having first and second ends housing said massaging balls, said sac is sized so that relative positions of the balls are variable within the sac when the device is not in use, said balls being free rolling.

2. The massage device of claim 1, wherein said sac is made from nylon.

3. The massage device of claim 1, wherein said massaging balls are solid and made from rubber.

4. The massage device of claim 1, wherein said sac is constructed from a substantially rectangular sheet of material.

5. The massage device of claim 1, wherein first and second ends of said sac are symmetrical in shape.

6. The massage device of claim 1, wherein said balls are approximately between 2.25 inches and 2.5 inches in diameter.

7. The massage device of claim 6, wherein a length of said sac is approximately between 10 inches and 12 inches.

8. The massage device of claim 1, wherein said balls and not connected to a separate device.

9. The massage device of claim 1, wherein said balls are resilient.

10. A method of massaging to release tension from muscles, the method comprising the steps of:
placing a massage device between a muscle to be massaged and a support surface, the massage device including first and second spherical massaging balls movable freely within an elongated closed sac; and
moving the massage device to massage the muscle.

11. The method of claim 10, further including the step of using only one massaging ball of the massage device to massage a single muscle area.

12. The method of claim 10, further including the step of using the two balls simultaneously to massage two different muscles areas.
